(19) United States
(12) Patent Application Publication
(10) Pub. No.: US 2004/0201694 A1
(43) Pub. Date: Oct. 14, 2004

(54) Noninvasive methods and apparatus for monitoring at least one hair characteristic

(76) Inventors: Vladimir Gartstein, Cincinnati, OH (US); Prashanth M. Kini, San Bruno, CA (US); Holly L. Krigbaum, Cincinnati, OH (US); Lee A. Oliver, Cincinnati, OH (US); Richard J. Schwen, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 09/778,652

(22) Filed: Feb. 7, 2001

(51) Int. Cl. H04N 5/225

(52) U.S. Cl. 348/207.99

(57) ABSTRACT

Noninvasive methods for monitoring at least one hair characteristic on a human or animal comprise magnifying a predetermined skin area having reference indicia to provide a first magnified image, digitally capturing the first magnified image to form a reference image, after a predetermined time period, magnifying the predetermined skin area to provide a second magnified image, and superimposing the second magnified image on the reference image to align the reference indicia in the second magnified image with the reference indicia in the reference image. Apparatus for noninvasive monitoring of at least one hair characteristic on a human or animal comprise a fiber optic remote head microscope, means for digitally capturing a first magnified image provided by the microscope to form a reference image, and means for superimposing a second magnified image provided by the microscope on the reference image and aligning reference indicia in the second magnified image with reference indicia in the reference image.

### FIELD OF THE INVENTION

The present invention is directed to non-invasive methods and apparatus for monitoring at least one hair characteristic on a human or animal. The methods and apparatus are particularly suitable for monitoring at least one hair characteristic in response to application of potential hair growth agents, potential hair loss prevention agents, potential hair growth retardation agents, hair maintenance agents, or other hair altering agents.

### BACKGROUND OF THE INVENTION

Androgenetic alopecia is a well known condition which modifies the duration, succession and frequency of hair cycles and generally leads to the progressive thinning of hair. Over the years, various active agents and treatment regimes have been studied to determine their ability to reverse androgenetic alopecia. Separately, it is sometimes desirable to remove hair or retard hair growth in various skin areas, for example to improve personal appearance, whereby evaluation of depilatories is necessary. In determining the viability of a particular active agent or treatment regime, both invasive and non-invasive methods and apparatus have been employed, with the advantages of non-invasive methods being apparent. Non-invasive methods for evaluating the viability of a particular hair growth active agent, hair loss prevention agent, hair growth retardation active agent, or treatment method typically monitor hair growth or hair coverage, with one or more hair characteristics being studied.

In many studies, photographic techniques employing phototricograms are used. Typically, a scalp area is shaved and, after a predetermined time period has passed, a photograph of the scalp area is taken using a macrolens, for example, on a 35 mm camera. Macrographs are projected on paper and subjected to visual evaluation or may be used for computer-assisted image analysis. Phototricogram techniques are disclosed, for example, by Canfield, Dermatologic Clinics, 14(4):713-721 (1996), Courtois et al, Skin Pharmacol., 7:84-89 (1994), Chatenay et al, Hair Research for the Next Millennium, Van Neste et al, Editors, Elsevier Science BV, pages 105-108 (1996), Courtois et al, British Journal of Dermatology, 132:86-93 (1995), and VanNeste, Trends in Human Hair Growth and Alopecia Research, (198_), pages 155-165. Optical microscopes have also been used for examining hair growth. For example, Hiyashi et al, British Journal of Dermatology, 125:123-129 (1991), disclose the use of an optical microscope, specifically a video microscope to view and record subject areas of the scalp. Hiyashi et al also disclose processing the recorded images to an image analyzer.

A continuing need exists for improved methods and apparatus for monitoring hair growth, hair loss prevention, hair growth retardation, and/or other hair characteristics in order to provide faster and easier methods for evaluating the viability, safety and/or effectiveness of an active agent and/or a treatment regime.

### SUMMARY OF THE INVENTION

Accordingly, it is an object of the present invention to provide improved methods and apparatus for monitoring at least one hair characteristic. It is a more specific object of the invention to provide noninvasive methods and apparatus for monitoring at least one hair characteristic on a human or animal. Further objects of the invention include providing methods and apparatus for noninvasive monitoring of at least one hair characteristic which provide faster and/or easier means for assessing the viability, safety and/or effectiveness of a particular active agent or treatment regime.

These and additional objects are provided by the methods and apparatus according to the present invention. In one embodiment, the invention is directed to noninvasive methods for monitoring at least one hair characteristic on a human or animal, which methods comprise magnifying a predetermined skin area having reference indicia to provide a first magnified image, digitally capturing the first magnified image to form a reference image, after a predetermined time period magnifying the predetermined skin area to provide a second magnified image, and superimposing the second magnified image on the reference image to align the reference indicia in the second magnified image with the reference indicia in the reference image.

In another embodiment, the invention is directed to noninvasive methods for monitoring at least one hair characteristic on a human or animal, which methods comprise magnifying a predetermined skin area having reference indicia to provide a first magnified image, digitally capturing the first magnified image to form a reference image using only a red color component, after a predetermined time period magnifying the predetermined skin area to provide a second magnified image, superimposing the second magnified image using green and blue color components on the reference image to align the reference indicia in the second image with the reference indicia in the reference image, and digitally capturing the superimposed images to form a treatment image, wherein the first and second magnified images are provided by contacting the predetermined skin area with a fiber optic remote head video microscope

In yet a further embodiment, the invention is directed to apparatus for noninvasive monitoring of at least one hair characteristic on a human or animal, which apparatus comprise a fiber optic remote head video microscope, means for digitally capturing a first magnified image provided by the microscope to form a reference image, and means for superimposing a second magnified image provided by the microscope on the reference image and aligning reference indicia in the second magnified image with reference indicia in the reference image.

The methods and apparatus according to the invention are advantageous in that the superimposition of the second magnified image with the reference image allows accurate assessment of even small increments of change in a hair characteristic such as hair growth As a result, the viability, safety and/or effectiveness of active agents or treatment regimes can be assessed more quickly and more easily than has been possible with various prior art hair monitoring methods and apparatus.

These and additional objects and advantages of the methods and apparatus of the invention will be more fully apparent in view of the following detailed description.

### BRIEF DESCRIPTION OF THE DRAWINGS

The detailed description will be more fully understood in view of the accompanying drawings in which:

FIG. 1 is a schematic diagram of a template which is suitable for use in one embodiment of the methods of the invention;

FIG. 2 is a schematic diagram of one embodiment of a system for performing the methods of the invention;

FIG. 3 is a schematic diagram of a second embodiment of a system for performing the methods of the invention; and

FIG. 4 is a schematic diagram of one embodiment of a fiber optic remote head video microscope for use in the methods and apparatus of the invention.

### DETAILED DESCRIPTION

The methods and apparatus of the present invention are adapted for monitoring at least one hair characteristic on a human or animal. Various hair characteristics may be monitored according to the methods and/or with use of the apparatus of the invention. For example, the methods and/or the apparatus of the invention may be used to monitor one or more hair characteristics including, but not limited to, hair count, hair coverage, hair growth, rate of hair growth, hair loss, hair diameter, hair width, hair density, hair color, hair shininess or reflectance, hair texture, hair thickness or fullness, hair growth retardation, hair fiber morphology, cuticle integrity, deposition of materials on hair, hair breakage, diagnosis of hair diseases, for example inherited or fungal diseases, anagen/telogen ratio, count and density of anagen and telogen hairs, length of anagen and telogen portions of a hair cycle, hair miniaturization, including reversal under therapy, polytrichia, proportions of vellus-like and terminal hairs, and the like. Additional hair characteristics which can be monitored using the methods and/or apparatus of the invention will be apparent to one skilled in the art and are within the scope of the invention defined by the present claims.

The methods and apparatus are particularly suitable for monitoring at least one hair characteristic in response to application of potential hair growth agents, potential hair loss prevention agents, potential hair growth retardation agents, or hair maintenance agents. Traditionally, hair growth and hair loss prevention are measured in a transitional scalp area, while hair growth retardation may be monitored in a scalp area or at another predetermined skin area where hair growth is undesirable. The methods and apparatus according to the present invention provide faster and easier methods for accurately evaluating the viability, safety and/or effectiveness of an active agent and/or a treatment regime. Advantageously, the methods and apparatus can be used to obtain accurate assessment of even small increments of change in a hair characteristic such as hair growth, whereby the viability or effectiveness of active agents or treatment regimes can be assessed from application of smaller amounts of active agents and/or in shorter time periods.

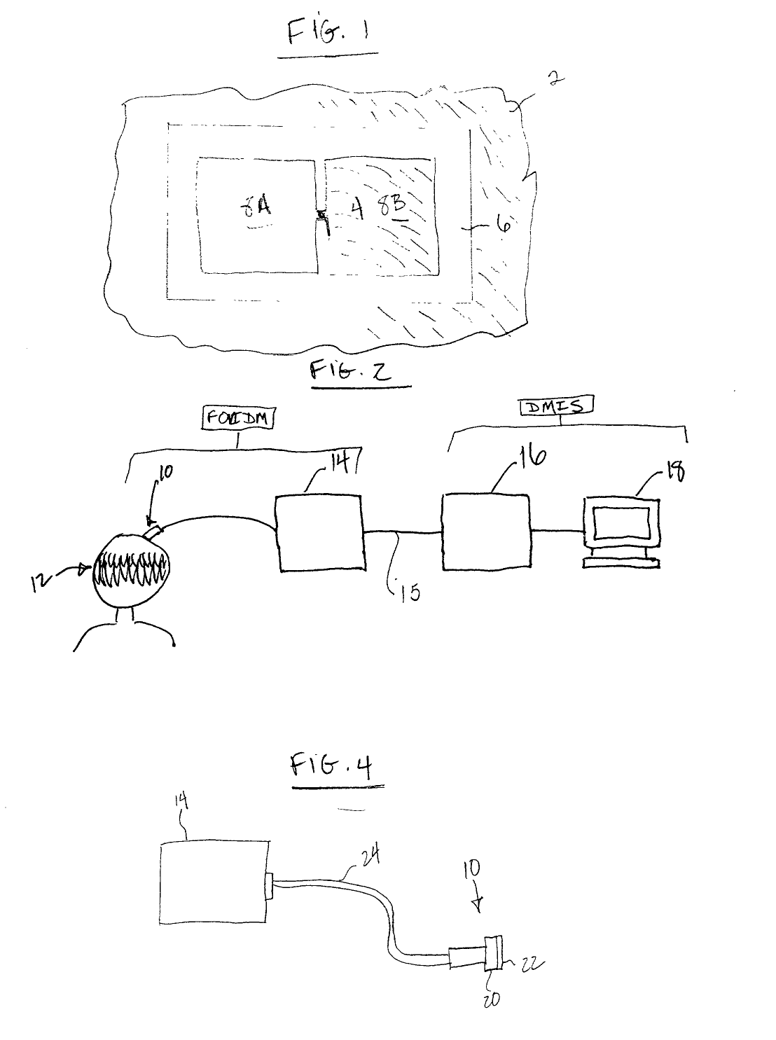

In one embodiment, the methods according to the present invention comprise successive monitoring of a predetermined skin area. Within the context of the present invention, the term “predetermined skin area” refers to any skin area on the body of the subject human or animal, including scalp areas and including transitional areas between areas of hair growth and balding areas. Preferably, the predetermined skin area is provided with one or more reference indicia to facilitate successive monitoring of the same predetermined skin area and evaluation and/or comparison of individual hairs, follicles and the like. While various indicia or markings may be employed as the reference indicia, in a preferred embodiment, the reference indicia comprises one or more tattoos which are permanently or semi-permanently marked on the predetermined skin area. In one embodiment, a single tattoo is permanently or semi-permanently marked on the skin to designate a predetermined skin area, for example on a scalp. The reference indicia can also serve as a means for locating or repositioning a template which is placed on the predetermined skin area to facilitate shaving or clipping the skin area prior to conducting the method according to the invention, as described in further detail below. FIG. 1 provides a schematic diagram of a predetermined skin area 2 having a reference indicia in the form of a single tattoo 4 which is used to position a template 6 on the skin. In one embodiment as shown in FIG. 1, the template may be positioned to designate a balding area 8A and a transitional area 8b for monitoring, whereby the template 6 facilitates clipping or shaving of the monitored areas. The tattoo 4 can also be used to locate the predetermined skin area for magnification and imaging as described below.

In studies to determine the effect of a particular active agent or treatment regime to reverse androgenetic alopecia, the predetermined skin area is preferably located in a transitional scalp area. Additionally, because the present methods and apparatus are particularly suitable for measuring even small increments of hair growth, the predetermined skin area which is monitored can be relatively small. In one embodiment, the predetermined skin area is not greater than about 10 cm² while in a further embodiment, the predetermined skin area is not greater than about 1 cm². In yet a further embodiment, the predetermined skin area is not greater than about 0.25 cm². For active agents which are topically applied, the monitoring of such a relatively small predetermined skin area is advantageous in that application of the topical agent is required only in the predetermined skin area. It will be apparent therefore that very small amounts of the active agent will be required to assess activity and/or effectiveness.

The methods for monitoring at least one hair characteristic according to the invention are noninvasive and comprise magnifying a predetermined skin area having the reference indicia to provide a first magnified image, digitally capturing the first magnified image to form a reference image, after a predetermined time period magnifying the predetermined skin area to provide a second magnified image, and superimposing the second magnified image on the reference image to align the reference indicia in the second magnified image with the reference indicia in the reference image. In a preferred embodiment, the method further comprises digitally capturing the superimposed images to form a treatment image. Within the scope of the invention, the term “treatment image” is used to refer to the image obtained by superimposing the second magnified image on the reference image, wherein the second image is obtained after a predetermined time period. It is not necessary that any treatment agent is applied to the hair during the predetermined time and it is fully within the scope of the methods of the invention that a hair characteristic is monitored over the predetermined period of time without any treatment having been applied to the hair. Additionally, any application of active, application of potential active, physical processing or other hair-directed activity or scalp-directed activity may be considered a treatment which may be made to the hair during the predetermined time period within the methods of the invention.

Various optical enlargement systems may be used in order to provide the magnified images according to the present invention. However, in a preferred embodiment, the magnified images are provided by contacting the predetermined skin area with a fiber optic remote head video microscope. FIG. 2 shows a schematic diagram of one embodiment of a system for performing the methods according to the invention. In FIG. 2, the system comprises a fiber optic video imaging device module (FOVIDM) and a digital macrograph imaging system (DMIS). The fiber optic video imaging device module includes a fiber optic remote head video microscope probe 10 to magnify a predetermined skin area of a person 12. The fiber optic remote head video microscope probe 10 is provided with a light source 14 and is connected with and supplies the magnified video image to the digital macrograph imaging system via an S-video cable 15. The digital macrograph imaging system includes computer hardware and software 16 operable to collect images from the magnified video image received from the fiber optic video imaging device module and displays the image digitally on a computer workstation module 18. The digital macrograph imaging system can also store digital images and can superimpose two or more digital images as desired. The images may be collected as a digital signal, for example using a digital video camera, or may be collected as an analog signal and then converted to digital form.

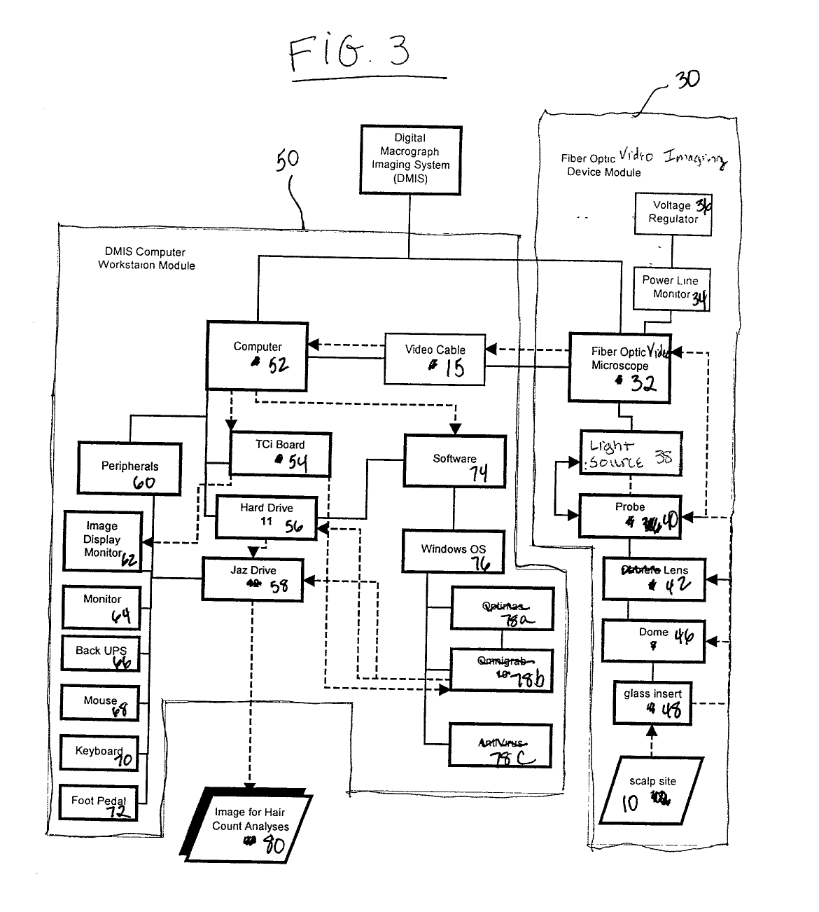

FIG. 3 sets forth a more specific schematic diagram of a system for practicing the methods and apparatus of the invention. In FIG. 3, the fiber optic video imaging device module (FOVIDM) is indicated at 30 while the digital micrograph imaging system (DMIS) is indicated at 50. The solid lines between components in FIG. 3 represent the architectural structure of the system while the dashed lines represent the image processing flow. The fiber optic imaging device module 30 includes a fiber optic video microscope 32, a power line monitor 34 and a voltage regulator 36. The fiber optic video microscope includes a light source unit 38 and a remote head probe 40 having a miniature video camera. The probe 40 is provided with a magnifying lens 42, a dome body 46 and a transparent member 48, which is preferably flat, for example a glass slide insert, and which is adapted for contact with the skin, suitably the scalp in a transition area, as well as skin at various anatomical sites, as will be described in greater detail below.

The fiber optic video microscope 32 of the fiber optic imaging device module is connected with a computer 52 in the digital macrograph imaging system via a video cable 15. The computer is provided with a frame grabber board 54, for example a TCi board as described in detail below, a hard drive 56 and a Jaz drive 58. Peripheral hardware provided with the computer includes peripherals 60, including an image display monitor 62, an additional display monitor 64, a backup drive 66, a mouse 68, a keyboard 70 and a foot pedal 72. The computer is provided with software 74 including a Windows operating system 76 which runs one or more software packages shown at 78a, 78b, 78c, described in further detail below. The digital macrograph imaging system produces a digital image 80 which can be used for hair growth monitoring, hair loss prevention monitoring, hair growth retardation monitoring, and/or monitoring other hair characteristics.

A more specific schematic of the fiber optic remote head video microscope for use in the methods and apparatus of the invention is set forth in FIG. 4. As shown in FIG. 4, the fiber optic remote head video microscope probe 10 includes a cable 24 which contains both fiber optic cable to provide skin area illumination from the light source 14 and video cable, for example S-video cable, to connect the miniature camera of the probe with the digital macrograph imaging system. The miniature video camera is preferably a color camera and collects video images in real time. The probe 10 may be provided with a magnification lens 20, for example having a plexiglass probe dome. In a preferred embodiment, the probe dome receives a glass cover 22, for example a microscope slide glass cut to fit the probe dome. Examples of suitable commercially available fiber optic remote head microscopes for use in the present invention include the Moritex MS-803 Scopeman® equipped with a 25X lens having a plexiglass probe dome adapted to receive a microscope slide glass cut to fit the probe dome, and the Hi-Scope fiber optic video microscope available from Hirox Company, Limited. The Hi-Scope comprises a light housing unit and a fiber optic remote probe with a lens and a miniature video camera, a non-transparent dome body and a transparent dome cap. The probe and lens of the Hi-Scope have adjustable features which facilitate changing focus and focal length.

The provision of a flat transparent member such as a glass slide on the fiber optic remote head microscope is advantageous in that it contacts the predetermined skin area and flattens hairs within the predetermined skin area. Thus, magnified images more clearly display hair characteristics of the predetermined skin area. A contact-improving liquid and/or an optical coupling liquid may be applied to the predetermined skin area prior to contact of the predetermined skin area with the fiber optic remote head microscope and more specifically prior to contact with the slide. Suitable contact-improving and/or optical coupling liquids include water, aqueous solutions, glycerol, oil, for example mineral oil, or the like. The optical coupling liquid is advantageous in that it matches the refractive index of the skin and causes skin wrinkles to fade in the magnified images, whereby the wrinkles become much more subtle, and it significantly reduces or eliminates interfering skin microstructure such as dry skin or flakes so that the hairs stand out against a very dull, uniform background in the magnified image. The liquid may also serve to enhance contrast of the hairs against the skin and eliminate glare from the skin. Upon contact with the predetermined skin area, the probe flattens hairs against the skin and therefore increases the ability to observe and compare hair characteristics. Typically, the glass slide or other contact portion of the fiber optic remote head video microscope will be sterilized, for example by replacement of the glass slide or other transparent member or cleaning of the probe surface between uses.

In one embodiment of the methods according to the present invention, the predetermined skin area is clipped or shaved prior to magnification to provide the first magnified image. In a specific embodiment, the predetermined skin area is clipped to a length of about 1 mm. By clipping the hair in the predetermined skin area, a reference image is created from which changes in a hair characteristic, for example growth, of all hairs in the predetermined skin area can be measured. A suitable clipper is a Wahl Clipper, Model 8900, optionally including a sculpturing blade (for example, Wahl Model 2041), which leaves very short hair suitable for image analysis according to the present methods, although numerous other clippers are available and suitable for use as described. The hair may optionally be dyed prior to the magnification steps according to the invention in order to enhance contrast of vellus hairs. A suitable hair dye is Just for Men, black, commercially available from Combe, Inc., although numerous other dyes are available and suitable for use as described.

The contact-improving or optical coupling liquid is then applied to the predetermined skin area and the predetermined skin area is magnified by contacting the skin area with the fiber optic remote head video microscope including a glass slide adapted to contact the predetermined skin area and flatten hairs within the area. In one embodiment, the predetermined skin area is magnified greater than ten-fold to provide magnified images. In another embodiment, the predetermined skin area is magnified greater than twenty-fold, and in yet another embodiment, the predetermined skin area is magnified twenty-five-fold, or more, to provide the magnified images.

The magnified images are digitally captured using the digital micrograph imaging system which typically will include hardware components as described above, comprising, for example, one or more computers, one or more monitors, a keyboard, a mouse and foot pedal, a backup device/drive, a frame grabber card and video cable. A suitable frame grabber comprises the TCi Ultra II frame grabber, manufactured by Coreco. This card is fit into a computer PCI slot to receive analog input from the fiber optic video microscope, for example via S-video cable, and converts a signal in analog form to digital format for storage onto the computer hard drive. Additionally, the TCi frame grabber board communicates with software to perform the following functions receiving analog signal via S-video cable, converting video signal from analog to digital form, image acquisition, image saving to hard drive, blending of images, for example the first and second images as discussed above, and controlling image brightness, color and contrast. Alternatively, a digital video camera can be used to avoid the need for converting the video signal from analog to digital form. Suitable software for communicating with the frame grabber and performing these functions comprises Optimus 6.2, a commercial image software package developed and marketed by Media Cybernetics Corporation and various software which is suitable for executing image acquisition tasks, including image capture, blending, storage and recall. Omnigrab software developed by The Procter & Gamble Company is suitable for use in the systems of the invention, although other software providing the same functions is commercially available and may be used. The software preferably operates on a Windows operating system.

In accordance with an important feature of the invention, the predetermined skin area can be magnified after a predetermined time period to provide a second magnified image and the second magnified image is superimposed on the reference image using the reference indicia. The superimposed images are then digitally captured to form a treatment image. The reference image and the treatment image can be compared to evaluate one or more hair characteristics over the predetermined time period, for example as a result of a treatment regime conducted during the predetermined time period between the first magnified image and the second magnified image. The methods and apparatus of the invention allow very accurate repositioning of the magnification apparatus, for example to within less than about 0.1 mm of the original position. A suitable length for the predetermined time period will depend, inter alia, on the hair characteristic which is to be monitored and any active agent, treatment regime or the like which is employed during the period. In monitoring the efficacy of potential hair growth agents, potential hair loss prevention agents or potential hair growth retardation agents, the predetermined time period may vary from several days to several weeks or more. In one embodiment, the predetermined time period is from 2 days to about 14 days, while in another embodiment, the predetermined time period is about 7 days.

In embodiments of the invention for determining the efficacy of potential hair growth agents, potential hair loss prevention agents or potential hair growth retardation agents, suitable hair characteristics for comparison between the reference and the treatment image include, but are not limited to, the respective lengths of individual hairs in the images, the respective hair shaft diameters of individual hairs in the images, the respective color of individual hairs in the images, the respective numbers of individual hairs in the images, and rate of hair growth Importantly, all measured characteristics may be stored in respect to individual hairs to permit identification of hair characteristics within any predefined range of characteristics.

An increase in the number of hairs that increase in length may be used as an indication of the number of telogen (resting) follicles stimulated into the growing (anagen) phase. An increase in hair diameter may be used to evaluate the number of undetermined (balding) hairs converting to terminal (non-balding) hairs, particularly based on the larger hair shaft diameter. Darkening of hair color can be used an indication of vellus hair conversion to terminal or undetermined hairs. The change in total hair can be used to evaluate the number of vellus (balding) hairs converting to terminal (non-balding) hairs based on increase in pigmentation or diameter. Because a hair must cycle from telogen to anagen multiple times before the conversion from a vellus hair to a terminal hair can occur, the monitoring of hair characteristics in accordance with the invention will detect an active hair growth effect at an earlier point. Additionally, the comparisons between reference images and treatment images as described above can be completely automated from the digital images which are obtained.

Additional magnified images may be obtained after subsequent periods of time to evaluate further hair characteristics. These hair characteristics may be evaluated with respect to the initial reference image or with respect to a previously obtained treatment image.

As will be apparent, accurate assessment of treatment regimes during the predetermined time period will be dependent on all images being consistently captured under the same lighting conditions and consistent optical arrangement. It is therefore preferred that the fiber optic video microscope and its interface with the software and hardware employs calibration procedures before and during each imaging session by comparing and adjusting lighting and/or optics of the fiber optic video microscope to known standard target values. In one embodiment, the calibration procedure uses standard color chips, for example MacBeth color standards, for white balancing and brightness/contrast measurement and/or a resolution chart. In a specific embodiment, the calibration is performed to within one gray level for a 24 bit color image.

In a specific embodiment of the methods, the various images are captured and displayed using different color components, e.g., red, green or blue, in order to more easily compare hair characteristics when the images are compared via superimposing. For example, in one embodiment, the reference image can be digitally captured and displayed in one of the red, green or blue color components, while the second magnified image is captured and displayed in the other two color components. More specifically, the reference image may be digitally captured and displayed using only the red color component, for example, while the second image which is superimposed uses a green and/or blue component. Preferably, the second image is superimposed in the green and blue components so that when the second image is perfectly superimposed with the reference image, the thus formed superimposed image is fully and naturally colored and may be digitally captured as such to provide the treatment image. The best color component choice for the reference image will be dependent on skin color and species, i.e., human or animal.

The specific embodiments and examples set forth above are provided for illustrative purposes only and are not intended to limit the scope of the following claims. Additional embodiments of the invention and advantages provided thereby will be apparent to one of ordinary skill in the art and are within the scope of the claims.

We claim:

1. A noninvasive method for monitoring at least one hair characteristic on a human or animal, comprising
magnifying a predetermined skin area having reference indicia to provide a first magnified image;
digitally capturing the first magnified image to form a reference image;
after a predetermined time period, magnifying the predetermined skin area to provide a second magnified image; and
superimposing the second magnified image on the reference image to align the reference indicia in the second magnified image with the reference indicia in the reference image.

2. The method according to claim 1, further comprising digitally capturing the superimposed images to form a treatment image.

3. The method according to claim 1, wherein the first and second magnified images are provided by contacting the predetermined skin area with a fiber optic remote head video microscope.

4. The method according to claim 3, wherein the fiber optic remote head video microscope includes a transparent member adapted to contact the predetermined skin area and flatten hairs within the predetermined skin area.

5. The method according to claim 4, wherein an optical coupling liquid is applied to the predetermined skin area prior to contact of the predetermined skin area with the fiber optic remote head video microscope.

6. The method according to claim 5, wherein the optical coupling liquid comprises water.

7. The method according to claim 5, wherein the optical coupling liquid comprises mineral oil.

8. The method according to claim 1, wherein the predetermined skin area comprises a scalp area.

9. The method according to claim 8, wherein the predetermined skin area comprises a transitional scalp area.

10. The method according to claim 1, wherein hair in the predetermined skin area is clipped prior to magnification to provide the first magnified image.

11. The method according to claim 1, wherein the predetermined skin area is magnified greater than ten fold to provide the first and second magnified images.

12. The method according to claim 1, wherein the predetermined skin area is magnified greater than twenty fold to provide the first and second magnified images.

13. The method according to claim 2, wherein the reference image and the treatment image are compared to evaluate the respective lengths of individual hairs in the images.

14. The method according to claim 2, wherein the reference image and the treatment image are compared to evaluate the respective hair shaft diameters of individual hairs in the images.

15. The method according to claim 2, wherein the reference image and the treatment image are compared to evaluate the respective numbers of individual hairs in the images.

16. The method according to claim 2, wherein the reference image and the treatment image are compared to evaluate the respective lengths, hair shaft diameters and numbers of individual hairs in the images.

17. The method according to claim 1, wherein the reference image is formed by digitally capturing the first magnified image using only a red color component.

18. The method according to claim 17, wherein the second magnified image is digitally captured using green and blue color components.

19. The method according to claim 2, wherein after a further predetermined time period, the predetermined skin area is magnified to provide a third magnified image, and further wherein the third magnified image is superimposed on the reference image or the treatment image to align the reference indicia in the third magnified image with the reference indicia in the reference image or the treatment image, respectively.

20. A noninvasive method for monitoring at least one hair characteristic on a human or animal, comprising
magnifying a predetermined skin area having reference indicia to provide a first magnified image;
digitally capturing the first magnified image to form a reference image using only a red color component;
after a predetermined time period, magnifying the predetermined skin area to provide a second magnified image;
superimposing the second magnified image using green and blue color components on the reference image to align the reference indicia in the second magnified image with the reference indicia in the reference image; and
digitally capturing the superimposed images to form a treatment image wherein the first and second magnified images are provided by contacting the predetermined skin area with a fiber optic remote head video microscope.

21. The method according to claim 23, wherein the predetermined skin area is magnified greater than twenty fold to provide the first and second magnified images.

22. The method according to claim 20, wherein the reference image and the treatment image are compared to evaluate the respective lengths of individual hairs in the images.

23. The method according to claim 20, wherein the reference image and the treatment image are compared to evaluate the respective hair shaft diameters of individual hairs in the images.

24. The method according to claim 20, wherein the reference image and the treatment image are compared to evaluate the respective numbers of individual hairs in the images.

25. The method according to claim 20, wherein the reference image and the treatment image are compared to evaluate the respective lengths, hair shaft diameters and numbers of individual hairs in the images.

26. The method according to claim 20, wherein the predetermined skin area comprises a transitional scalp area.

27. Apparatus for noninvasive monitoring of at least one hair characteristic on a human or animal, comprising
a fiber optic remote head video microscope;
means for digitally capturing a first magnified image provided by the microscope to form a reference image; and
means for superimposing a second magnified image provided by the microscope on the reference image and aligning reference indicia in the second magnified image with reference indicia in the reference image.

28. The apparatus according to claim 27, further comprising means for digitally capturing the superimposed images to form a treatment image.

29. The apparatus according to claim 27, wherein the fiber optic remote head microscope includes a transparent member adapted to contact a skin area and flatten hairs within the skin area.

30. The apparatus according to claim 27, further comprising a computer screen for viewing the magnified images.

31. The apparatus according to claim 30, wherein the computer screen is adapted for viewing the digitally captured image.

32. The apparatus according to claim 31, wherein the computer screen is adapted for viewing the superimposed images.

33. The apparatus according to claim 28, wherein the means for digitally capturing a first magnified image forms a reference image using only a red color component.

34. The apparatus according to claim 33, wherein the means for digitally capturing the superimposed images uses a second magnified image using only green and blue color components.
